(19) United States
(12) Patent Application Publication
(10) Pub. No.: US 2013/0026781 A1
(43) Pub. Date: Jan. 31, 2013

(54) Hail stopper

(71) Applicants: Gregory Lee Hobson, Topeka, KS (US); Mitchell Gregory Hobson, (US)

(72) Inventors: Gregory Lee Hobson, Topeka, KS (US); Mitchell Gregory Hobson, (US)

(21) Appl. No.: 13/136,126

(22) Filed: Jul. 25, 2011

(51) Int. Cl. B62D 25/06

(52) U.S. Cl. 296/136.02

(57) ABSTRACT

Over the years storms have become more powerful and producing damaging hail there is no protection from this, hail stopper will help an owner protect their vehicle from damage for people who don't have a garage this is the next best thing. Also helps protect your vehicle from freezing rain, no more frozen windshields or doors, no more wasting time scrapping at your windows to get the ice off, just remove the hail stopper and you will be ready to go.

### BACKGROUND OF INVENTION

Man has been using various types of protection for vehicles, from car covers to sheds, tents, garages, and car ports, Though these devices are effective but everyone does not have the room or can't afford a car port or a garages, that's why they do not compare to what we have designed, also this product is portable and can be carried around with you in case you are out taking care of business this product can save you thousands of dollar of damage that we can't afford, the hail stopper is placed over a vehicle when damaging weather is forecast such as hail storms, powerful thunder storms with winds carrying debris such as small branches and trash that would damage a vehicle,

### BRIEF SUMMARY OF INVENTION

The hail stopper is placed onto a vehicle when bad weather is forecasted with hail storm, strong winds carrying debris, to protect your car from damage, hail stopper is designed to protect a vehicle from hail, dust and other material that could damage your vehicle. The hail stopper protection material is made oval or square, the hail stopper is made only in two sizes medium and large, hail stopper is designed to protect only the parts that are being covered also, this produce must be applied properly so that hail stopper stay in place,

### BRIEF DESCRIPTION OF DRAWING

FIG. 1. Front view of the Hail stopper in accordance to with the present invention,

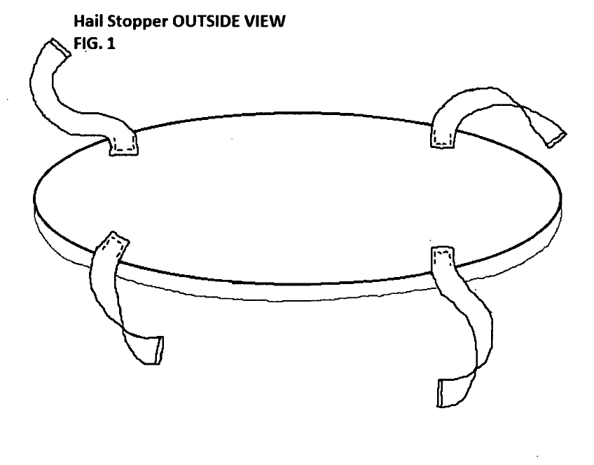

FIG. 2. Shows a fragmented prospected view of the hail stopper that will be used to help give a detailed description of the embodiment,

### DETAILED DESCRIPTION OF PREFERRED EMBODIMENT

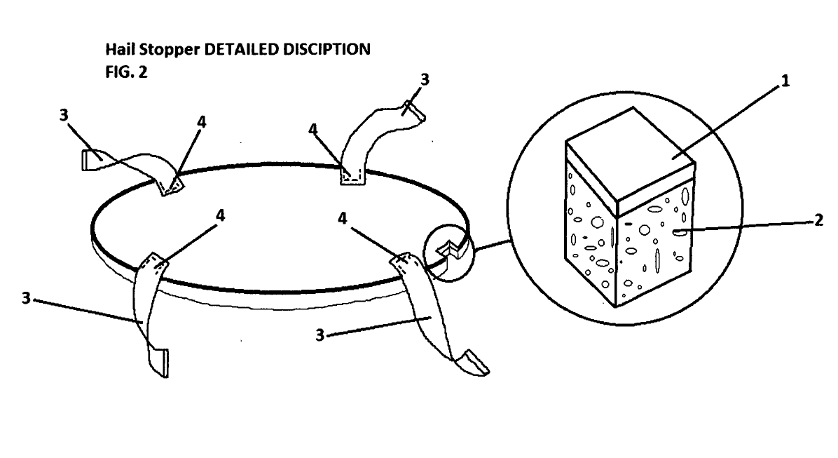

With reference to drawing FIG. 2 please note FIG. 2 is a fragmented view that will help give a full description with respect to the embodiment and will become more apparent, and compliant with constitutional purpose of the patents laws, “to promote the progress of science and useful art” (article, section 8), applicant submit the following disclosure of the embodiment. With reference to drawing FIG. 2, number 1 is ¼ inch rubber covering is rubber cement glued to 2.5 to 3 inch foam, also there are four number 3 velcro straps that are sowed into the ¼ inch rubber covering number 4, this will allows the velcro straps to be connected under the vehicle to one another, the two front go together and the two back go together, this will allow the straps number 3 to be secured onto the vehicle,

The invention claimed is:

1. Hail stopper comprising: A generally oval or square mat like covering, wherein a ¼ inch rubber covering is glued to a 2.5 to 3 inch foam material, wherein 4 velcro straps are sowed to said ¼ inch rubber covering at equal distances apart, wherein said velcro straps are long enough to go under vehicle and be attached.
